(19) United States
(12) Patent Application Publication
(10) Pub. No.: US 2021/0392926 A1
(43) Pub. Date: Dec. 23, 2021

(54) Weighting Agents for Citrus Beverages

(71) Applicant: The Coca-Cola Company, Atlanta, GA (US)

(72) Inventors: Youlung CHEN, Marietta, GA (US); Youngsuk HEO, Cumming, GA (US); Xiaoliang TAN, Marietta, GA (US)

(21) Appl. No.: 17/282,213

(22) PCT Filed: Oct. 4, 2019
(86) PCT No.: PCT/US2019/054800

§ 371 Date: Apr. 1, 2021

Related U.S. Application Data
(60) Provisional application No. 62/741,029, filed on Oct. 4, 2018.

(51) Int. Cl. A23L 2/62; A23L 2/385; A23L 2/44; B01D 3/12

(52) U.S. Cl. CPC A23L 2/62; A23L 2/385; A23V 2002/00; B01D 3/12; A23L 2/44

(57) ABSTRACT

A weighting gent is disclosed for use in beverage emulsions, as well as beverage emulsions (e.g., citrus beverages or beverage concentrates) containing the same. Methods of making and using such weighting agents are described, as well as methods of making such beverages emulsions.

### CROSS REFERENCE TO RELATED APPLICATION

This application claims priority to U.S. Provisional Application No. 62/741,029, filed Oct. 4, 2018, which is incorporated herein in its entirety.

### FIELD OF THE INVENTION

Disclosed herein are weighting agents and beverage emulsions (e.g., citrus beverages or beverage concentrates) containing the same, as well as methods of making and using such weighting agents. Also disclosed are methods of making such beverage emulsions.

### BACKGROUND OF THE INVENTION

Weighting agents are used in beverage emulsions to promote stability and turbidity. Known agents include sucrose acetate isobutyrate (SAIB), brominated vegetable oil (BVO) and ester gum.

Regulatory issues have impacted the use of weighting agents. In the 1970's, BVO was removed from the Generally Recognized as Safe (GRAS) list in the United States. BVO remains subject to review by the Food and Drug Administration (FDA) and is currently only permissible for use in concentrations of about 15 ppm. In some countries, BVO is impermissible for use in any concentration.

Weighting agents such as SAIB and ester gum provides alternatives to the use of BVO. Yet, these agents have a lower specific gravity than BVO. Moreover, they are also subject to concentration limitations, restricting the types of products they may be used in. Ester gum, for example, is limited to 100 ppm, while SAIB is limited to 300 μm.

Known weighting agents have also been associated with taste problems.

There remains a need for alternative weighting agents in the art.

### SUMMARY OF THE INVENTION

Disclosed herein are weighting agents and beverage emulsions (e.g., citrus beverages or beverage concentrates) comprising the same, as well as methods of making and using weighting agents. Also disclosed are methods of making such beverage emulsions. The weighting agents disclosed herein provide advantages with respect to physical stability, turbidity, sensory issues and/or regulatory issues.

In a first aspect, disclosed herein is a weighting agent comprising a glycerol ester of purified gum rosin.

In one embodiment, the weighting agent comprises a glycerol ester of purified gum rosin wherein the glycerol ester of purified gum rosin comprises (i) greater than about 92% resin acids and (ii) less than about 1% unknown compounds, wherein the number of resin acids in the purified gum rosin is less than 12 but greater than zero.

In further particular embodiment, the weighting agent comprises a glycerol ester of purified gum rosin, wherein the glycerol ester of purified gum rosin comprises (i) greater than about 94% resin acids and (ii) less than about 1% unknown compounds, wherein the number of resin acids in the purified gum rosin is less than 12 but greater than zero.

In a particular embodiment, the number of resin acids in the glycerol ester of purified gum rosin is 10 or less but greater than zero.

In a particular embodiment, the number of resin acids in the glycerol ester of purified gum rosin is 11, 10, 9, 8 or 7.

In one embodiment, the area percentage (%) of resin acids and monoglycerides by high purification liquid chromatography (HPLC) is about 60% less for the weighting agent disclosed herein than conventional ester gums. In a particular embodiment, the area percentage (%) is decreased for diglycerides and increased for triglycerides for the weighting agent disclosed herein compared to conventional ester gums.

In a second aspect, disclosed herein is a beverage emulsion comprises an oil phase, wherein the oil phase comprising an effective amount of the weighting agent as disclosed herein.

In one embodiment, the beverage emulsion is a beverage concentrate or a finished beverage (i.e., a diluted beverage concentrate).

In one embodiment, the beverage emulsion contains at least one flavor oil, such as a citrus oil.

In a particular embodiment, the beverage emulsion is a lemon-lime soda or an orange soda.

In another particular embodiment, the beverage emulsion is a juice.

In another embodiment, the beverage emulsion is shelf stable and more particularly, maintains a suitable particle size for at least about 4 months, at least about 6 months, at least about 8 months or 12 months or greater.

In a particular embodiment, the beverage emulsion has similar or equal stability or shelf life relative to a beverage emulsion containing a conventional ester gum. In one embodiment, the stability or shelf life of the beverage emulsion disclosed herein is improved relative to a beverage emulsion containing a conventional ester gum.

In one embodiment, the beverage emulsion of the present invention has a shelf life, when packaged, of about 4 to about 12 weeks. In another embodiment, the packaged beverage emulsion has a shelf life of at least 12 weeks.

In one embodiment, the weighting agent disclosed herein is the only weighting agent present in the beverage emulsion.

In a third aspect, disclosed herein is a method of preparing the weighting agent disclosed herein, comprising: (i) providing a suitable starting material (e.g., a crude gum rosin); and (ii) purifying the suitable starting material to provide the weighting agent, wherein the purifying method is a chemical purification method, a physical purification method or a combination thereof.

In a particular embodiment, the chemical purification method is a resin acid/salt formation method, as in FIG. 1.

In another particular embodiment, the physical method is a vacuum distillation method, selected from the group consisting of physical high temperature vacuum distillation and molecular distillation.

In one embodiment, the weighting agent contains fewer than 12, fewer than 10 or fewer than 8 resin acids. the weighting agent comprises greater than about 85%, greater than about 90% or greater than about 95% resin acids and less than 1% unknown compounds.

In other embodiments, the weighting agent contains between about 90 and about 99% resin acids, more particularly, about 90%, about 91%, about 92%, about 93%, about 94%, about 95%, about 96%, about 97%, about 98% or about 99% resin acids.

In one embodiment, the method disclosed herein is at scale, i.e., provides more than 100 kg of starting material.

In a fourth aspect, disclosed herein is a method of enhancing the stability of a beverage emulsion, comprising (i) providing the weighting agent disclosed herein; and (ii) adding an effective amount of the weighting agent to the oil-phase of a beverage emulsion, thereby enhancing the stability of the beverage emulsion.

In one embodiment, the beverage emulsion is a citrus beverage, such as a juice or citrus-flavored soda.

### BRIEF DESCRIPTION OF THE FIGURES

FIG. 1: depicts a chemical purification strategy for crude gum rosin as disclosed herein.

FIG. 2: depicts a gas chromatography-mass spectrometry (GC/MS) spectrum of crude gum resin vs. a purified gum rosin.

FIG. 3: depicts the results of high performance liquid chromatrography (HPLC) of a conventional ester gum vs. the glycerol esterified purified gum rosin disclosed herein.

FIG. 4: depicts an HPLC chromatogram of a crude gum rosin purified by vacuum distillation as described herein.

FIG. 5: depicts an HPLC chromatogram of a glycerol ester of purified gum rosin disclosed herein.

### DETAILED DESCRIPTION OF THE INVENTION

The present invention provides weighting agents and compositions (e.g., beverage emulsions) comprising the same. The present invention also extends to methods of making and using such weighting agents, as well as methods of making compositions comprising the same including consumables (e.g., finished beverages).

### I. Definitions

The term “beverage emulsion”, as used herein, refers to beverage flavor emulsions and beverage cloud emulsions. Beverage flavor emulsions provide the beverage with flavor, cloudiness, and color as in certain formulas. Beverage cloud emulsions provide only cloudiness with no flavor. Both beverage emulsions are composed of an oil phase and a water phase, and they are classified as oil-in-water (o/w) emulsions. The oil phase consists of oils, such as flavor oils, and the water phase consists of usually consists of various types of hydrocolloid, acid, preservative, and coloring. Beverage emulsions are generally prepared as beverage concentrates (e.g. >10% oil) and then diluted in another solution (e.g., a sugar solution) to provide the finished beverage (e.g., <0.1% oil).

The term “clarity”, as used herein, refers to the transparency of a substance, assessed by eye, i.e. optically. A liquid which appears transparent does so because it scatters little or no visible light. Clarity is related to turbidity. For example, water appears visually clear if it has a turbidity of less than SNTU.

The term “coalescing”, as used herein, refers to oil droplets merging together to form a large droplet and is due to disruption in the sheaths of oil droplets within aggregates.

The term “consumables,” as used herein, mean substances which are contacted with the mouth of man or animal, including substances which are taken into and subsequently ejected from the mouth and substances which are drunk, eaten, swallowed or otherwise ingested, and are safe for human or animal consumption when used in a generally acceptable range. A finished beverage, such as a diluted beverage concentrate, provides one non-limiting example of a consumable.

The term “container” or “package”, as used herein, refers to a package or container that contains the beverage emulsions (e.g., in concentrated or diluted form) disclosed herein. The specific type of package or container, either of a single-serving size or any other size.

The term “conventional ester gum”, as used herein, refers to an ester gum presently sold commercially for use in food and beverage applications. Glycerol esters of wood rosin (GEWR) are sold commercially by Pinova USA, while glycerol esters of gum rosin (GEGR) are sold commercially by Rosinas (Mexico) and Eastman Chemical (USA). The conventional ester gums differ from the weighting agents disclosed herein with respect to one or more properties, including but not limited to purity and the number of compounds present, including resin acids.

The term “density”, as used herein, refers to the mass of a unit volume of a substance, e.g., an oil phase or aqueous phase of an emulsion. Density can be measured according to methods know in the art. For example, density can be measured using a specific gravity bottle designed for viscous fluids. In particular, oil phase density can be determined by weighing the mass of oil (MO) and then the mass of water (MW) required to fill the specific gravity bottle at 25.0° C. The density of the oil (PO) can then be calculated from PO=PWMO/MW where PW is the density of distilled water at the measurement temperature

The term “edible oil”, as used herein, refers to oils fit for human consumption.

The term “emulsifier”, as used herein, refers to surface active agents that absorb to the surface of droplets formed during homogenization, forming a protective coating that prevents the droplets from aggregating. Representative, non-limiting examples of emulsifiers include small molecule surfactants, phospholipids, proteins and polysaccharides.

The term “emulsion”, as used herein, refers to a class of disperse systems containing two immiscible liquids (e.g. oil and water), with one of the liquids being dispersed as small spherical droplets (the dispersed phase) in the other (the continuous phase). Emulsions can be characterized by the nature of the emulsifier, the structure or of the emulsion or both. Representative emulsions by structure include oil-in-water (o/w) emulsions, water-in-oil (w/o) emulsions and oil-in-oil (w/o) emulsions. The oil content of emulsions may vary, ranging from about 0.5% to about 80%. More complex emulsions are possible, e.g., such as multiple emulsions.

The term “emulsion stability”, as used herein, refers to the ability of an emulsion to resist changes to its properties over time and determines, among other things, the shelf life of an emulsion. Such changes can be due to, for example, one or more physical mechanisms (e.g., gravitation separation or droplet aggregation). Emulsion stability can be assessed with reference to the physical or chemical stability of an emulsion. Physical stability, in particular, refers to the ability to resist changes in special distribution of ingredients over time. Stability can be measured with respect to rheology of component phases, oil droplet particle size and distribution and density difference of water and oil phases. Emulsion stability can be assessed during one or more phases of the product life cycle, under conditions of storage, transport and utilization, for example. Moreover, emulsion stability can be assessed one or more times during a given phase, e.g., multiple times during storage.

The term “essential oil”, as used herein, refers to oils containing volatile aroma compounds from plants. Essential oils are also known as volatile oils, ethereal oils or aetherolea. Essential oils contain terpenes, which are water-insoluble hydrocarbon components that are primarily responsible for the cloudy appearance of such oils. Terpenes may be hemiterpenes, i.e. contain a single isoprene unit; monoterpenes, i.e. contain two isoprene units; or polyterpenes having more than two isoprene units. Preferably, the essential oils are natural essential oils, i.e. oils that can be extracted from the above enumerated plants and variations thereof. Synthetic essential oils, i.e. essential oils which are lab made, can also be used.

The term “flavor oil”, as used herein, refers to an oil that that provides flavor as well as some of the cloudiness to a beverage emulsion. Citrus oil is a representative example of a flavor oil.

The term “flocculation” refers to the aggregation of oil droplets without coalescing.

The term “glycerol ester of gum rosin” or “GEGR” refers to complex mixture of glycerol di- and triesters of resin acids from gum rosin. Refined gum rosin is obtained by subjecting oleoresin from a live pine tree to washing, filtration and distillation. Refined gum rosin contains approximately 90% resin acids and about 10% neutrals (non-acidic saponifiable and unsaponifiable substances). To make GEGR, refined gum rosin is reacted with glycerin to produce the glycerol ester. Commercially available GEGR generally contains between about 75 to about 79% resin acids and about 15 to about 20% neutrals, although this may vary by species.

The term “glycerol ester of wood rosin” or “GEWR” refers to complex mixture of glycerol di- and triesters of resin acids from wood rosin. It is manufactured by means of a two-step process. First, solvent extraction and refining of wood rosin from aged pine stumps is performed. Second, the refined wood rosin is esterified and the final product is purified. Refined wood rosin contains approximately 90% resin acids and 10% neutrals (non-acidic saponifiable and unsaponifiable substances). To make GEWR, refined wood rosin is reacted with glycerin to produce the glycerol ester. Commercially available GEWR generally contains contain between about 85 to about 88% resin acids and about 9% to about 17% neutrals.

The term “lifting”, as used herein, refers to the appearance of a clear layer of liquid at the bottom of a bottled beverage emulsion, reflecting lifting of the emulsion within the beverage container up from the bottom.

The term “oiling off”, as used herein, refers to the formation of an oily layer on the top of the beverage.

The term “oil-in-water emulsion” or “o/w emulsion” refers to a composition where small droplets of oil are immersed in water or another liquid. Oil is therefore the dispersed phase, while water is the dispersion medium.

The term “particle size”, as used herein, refers to the size of the oil component in a liquid-liquid system. It is usually expressed in terms of an average or mean radius or diameter. Generally, the stability of an emulsion can be enhanced by reducing the size of the particles. Technologies for measuring mean particle size are known in the art including, for example, dynamic light scattering and/or single-particle optical sensing, using an apparatus such as the Accusizer™ and Nicomp™ series of instruments available from Particle Sizing Systems (Santa Barbara, USA), the Zetasizer™ instruments from Malvern Instruments (UK), or the Particle Size Distribution Analyzer instruments from Horiba (Kyoto, Japan). A conventional emulsion generally comprises particles having a diameter of greater than about 100 nm, e.g., 0.5 to about 5 while a nanoemulsion generally comprises particles having a diameter of less than about 100 nm but still large enough to be unstable.

The term “particle size distribution” or “PSD”, as used herein, refers to the concentration of droplets in different sizes classes. The concentration of particles within a particular size is expressed in terms of volume or percent. PSD can be used to estimate the quality of the beverage emulsion in concentrate and/or to predict the stability of the beverage emulsion when it is diluted to provide a finished beverage at a later date. The term “ppm” as used herein refers to parts-per-million.

The term “phase inversion”, as used herein, refers to a process by which an w/o emulsion is converted to a o/w emulsion or a o/w emulsion is converted to a w/o emulsion.

The term “pre-emulsion”, as used herein, refers to an emulsion formed prior to homogenization. Homogenization reduces the droplet size of a pre-emulsion to form a finer emulsion.

The term “resin” or “pitch”, as used herein, refers to the secretion from a tree (e.g., a pine tree) caused by broken limbs or cuts in the tree trunk. Many plants, particularly woody plants, produce resin in response to injury.

The term “resin acid” refers to any of several related carboxylic found in tree resins, including abietadiene-type, abietatriene-type, abietatetraene-type, pimarane-type, ester-type and oxo-type resin acids.

The term “ringing” or “creaming”, as used herein, refers to the formation of a whitish ‘ring” and the neck of the beverage container. It does not involve a breaking of the emulsion, but rather a separation of the emulsion into two emulsions, one which is richer in the dispersed phase and another which is poorer in the dispersed phase than the original emulsion. The oil droplets then form a dense layer at the surface of the emulsion without change in droplet size. Creaming is a form of gravitation separation.

The term “rosin” or “colophony”, as used herein, refers to a mixture of resin acids produced from the distillation of pitch. Gum rosins are produced through the distillation of gum resins, while wood rosins are produced through the distillation of old stumps.

The term “sedimentation”, as used herein, refers to separation and precipitation of the weighting agent from the oil phase in a beverage emulsion. Sedimentation is a form of gravitation separation.

The term “shelf life”, as used herein, generally refers to the period of time that a product can be expected to keep without appreciable change in quality, safety or character. End of shelf life parameters may include, for example, physical characteristics, sensory characteristics, chemical characteristics, functional characteristics, microbiological characteristics or a combination thereof. Shelf-life may be measured in real time or under accelerated conditions (e.g., by increasing storage temperature).

The term “shelf stable”, as used herein, refers to a packaged beverage that does not require refrigeration bur rather, can be stored at ambient (room) temperatures (20-25° C.) for prolonged periods (e.g., more than about 10 days). This is in contrast to “chilled” beverages that generally must be refrigerated and can normally only be stored under ambient conditions for only a short time (e.g., up to about 10 days).

The term “specific gravity”, as used herein, refers to the ratio of the density of a substance to the density of a standard substance, such as water at its most dense (at 4° C. or 39.2° F.) for a liquid. Liquids with a specific gravity of 1 are neutrally buoyant in water, while those with a specific gravity SG greater than 1 are denser than water and will, disregarding surface tension effects, sink in it. Liquids with a specific gravity less than 1 are less dense than water and will float on it.

The term “storage conditions”, as used herein, refers to the conditions under which a given product (e.g., a beverage emulsion) is stored including both extrinsic and intrinsic factors. Such conditions include, without limitation, temperature (room temperature, hot, cold), light (e.g., natural or artificial visible or ultraviolet waves) and pH.

The term “striation”, as used herein, refers to the appearance of two or more distinctive lawyers within a bottle beverage emulsion, reflecting different degrees of cloudiness.

The term “turbidity”, as used herein, refers to the clarity of a liquid. A liquid with high turbidity will appear cloudy or hazy, whilst one with low turbidity will appear clear. Turbidity is determined in Nephelometric Turbidity Units (NTU) using a nephelometer (also known as a turbidimeter, e.g. Hach 2100N-Germany), which measures the propensity of particles in the liquid to scatter light. A turbidimeter is calibrated using pre-mixed Formazin solutions (StabCal 26621-10, Hach-Germany) from 0.1, 20, 200, 1000, 4000 NTU.

The term “weighting agent”, as used herein, refers to a material that is used to increase the density of a composition. Generally, weighting agents are oil soluble, flavorless and have a specific gravity greater than oil. The function of the weighting agent is generally to increase the density of the oil phase, decreasing the likelihood of phase separation. The density of the oil phase after the addition of a weighting agent is the weighted average of the density of the oil and the density of the weighting agent. Representative, non-limiting, weighting agents known in the art for use with beverages include ester gum, SAIB, dammar gum and BVO.

The term “viscosity”, as used herein, refers to the measure of resistance to gradual deformation by shear or tensile strength. With respect to liquids, it corresponds to the informal concept of “thickness.”

### II. Weighting Agent

In exemplary embodiments, a weighting agent is disclosed herein.

In another embodiment, the weighting agent comprises a glycerol ester of purified gum rosin (GEPGR). In a particular embodiment, the weighting agent differs from conventional ester gums or purified gum resins currently used as weighting agents for beverages with respect to one or more properties, such as purity and/or the number of resin acids present.

In a particular embodiment, the weighting agent comprises greater than about 80% resin acids, greater than about 85% resin acids, greater than about 90% resin acids, or greater than about 91% resin acids, or greater than about 92% resin acids, or greater than about 93% resin acids or greater than about 94% resin acids, or greater than about 95% resin acids, or greater than about 96% resin acids or greater than about 97% resin acids, or greater than about 98% resin acids or greater than about 99% resin acids. In certain embodiments, the weighting agent contains about 1% or less unknowns. In certain embodiments, the weighting agent contains fewer than 15, fewer than 12, fewer than 10, fewer than 8 or fewer than 6 resin acids.

In one embodiment, the weighting agent comprises between about 88 and about 99% resin acids. In a particular embodiment, the weighting agent comprises between about 90 and about 98%, about 91 and about 97%, or about 92 and about 95% resin acids.

In a further embodiment, the weighting agent contains between about 90 and about 99% resin acids. In a particular embodiment, the weighting agent contains between about 91 and about 98% resin acids, between about 93 and about 97% resin acids or between about 94 and about 95% resin acids.

In another embodiment, the weighting agent comprises about 85%, about 86%, about 87%, about 88%, about 89%, about 90%, about 91%, about 92%, about 93%, about 94%, about 95%, about 96%, about 97%, about 98%, about 99% or more resin acids.

In one embodiment, the weighting agent comprises between 6 and 15 resin acids, between 7 and 14 resin acids, between 8 and 13 resin acids, or between 9 and 11 resin acids. In a particular embodiment, the weight agent comprises 8, 9, 10 or 11 resin acids. In a particular embodiment, the weighting agent comprises 12 or fewer resin acids, or more particularly, 10 or fewer resin acids.

The weighting agent of the present invention can be derived from natural sources. In one embodiment, the weighting agent is derived from a plant belonging to the belonging to Pinaceae (mainly Pinus genus). The pine tree species may be any suitable species, such as P. elliottii Engelm ((Brazil, Argentina, S. Africa, USA, Kenya), P. massoniana and P. kesiya Royale ex Gordon (China), P. pinaster Aiton (Portugal), P. merkusii Jungh. and Vriese (Indonesia and Viet Nam), P. roxburghii Sarg. (India and Pakistan), P. oocarp Schilde (Mexico and Hondurans), P. caribou (S. Africa, Kenya, Venezuela), and P. radiate (Kenya). In certain embodiments, the weighting agent is derived from more than one species of pine. In another embodiment, the purified gum resin is derived from another conifer or broad leaf tree.

There three sources of rosin. “Gum rosin” refers to a rosin derived from a living tree, such as living pine tree. “Wood rosin” is rosin derived from the stomp of a previously harvested tree (typically, several years post-harvest). A third type of rosin, “tail oil rosin”, is obtained from crude tall oil (CTO), a by-product of the Kraft sulphate pulping process

Oleoresin can be tapped from living trees by means of a repeated wounding process, which removes the bark and tissues beneath it, optionally followed by application of a chemical stimulant. Once collected, the crude oleoresin is subject to distillation to provide gum turpentine (the volatile fraction) and crude gum rosin (the solid fraction). A common pine oleoresin will contain about 70% rosin, 15% turpentine and 15% debris and water. Yields of rosin and turpentine are typically in the range of about 700 kg and about 160 liters (140 kg), respectively, from one ton of resin.

Rosins derived from both living trees and both aged wood stumps are composed of approximately 90% resin acids and 10% non-acidic (neutral) components. The resin acids are monocarboxilic acids with alkylated hydrophenanthrene nucleus and include (i) the abietic acid-type resin acids characterized by conjugated double bond and (ii) the pimaric acid-type resin acids without conjugated double bond. Abietic-type acids include abietic, neoabietic, palustric, levoprimaric and dihydroabietic resin acids. Pimaric-type acids include pimaric, isopimaric and Sandoracopimaric acids. The neutral compounds include stilbene compounds and other hydrocarbons.

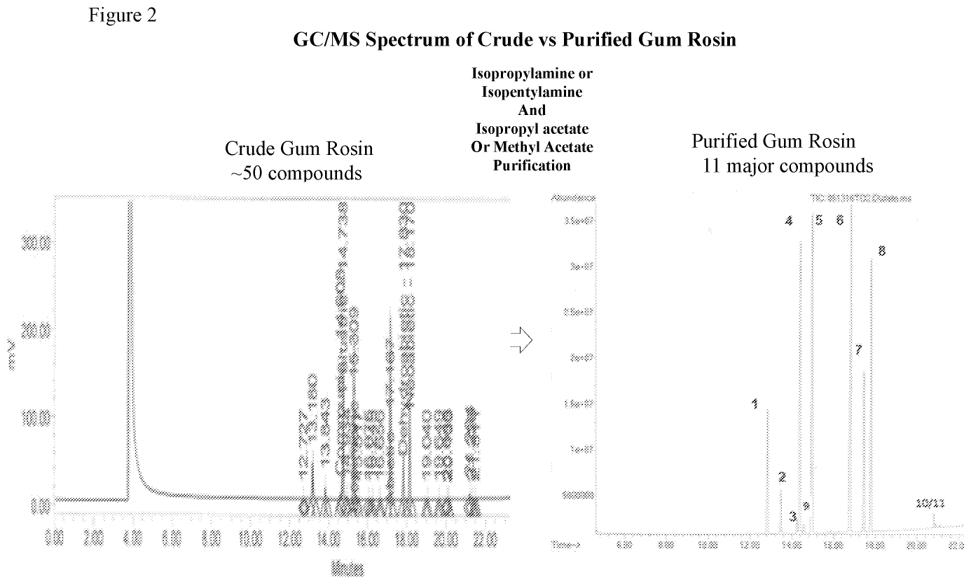

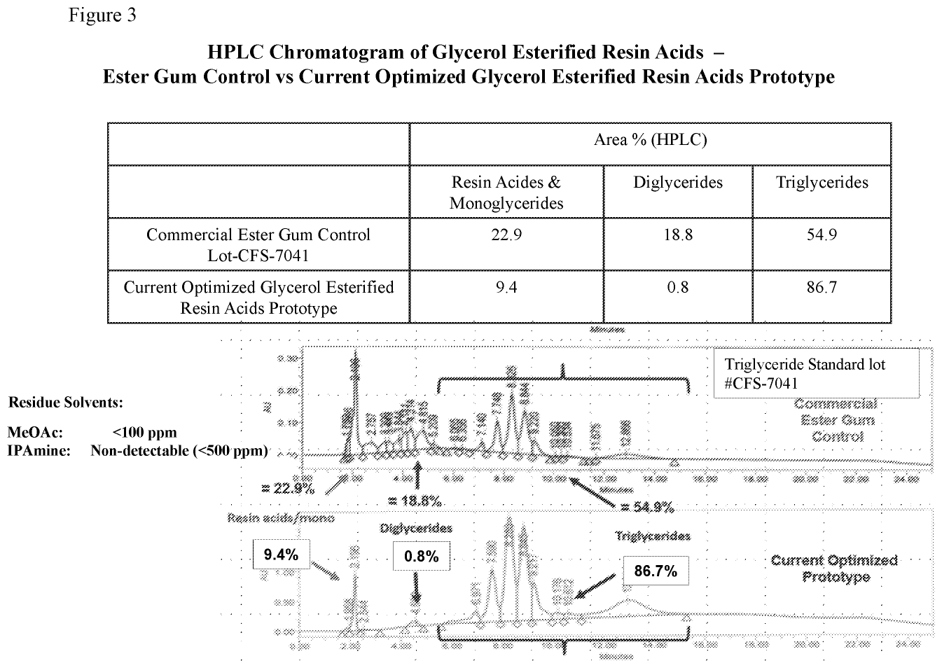

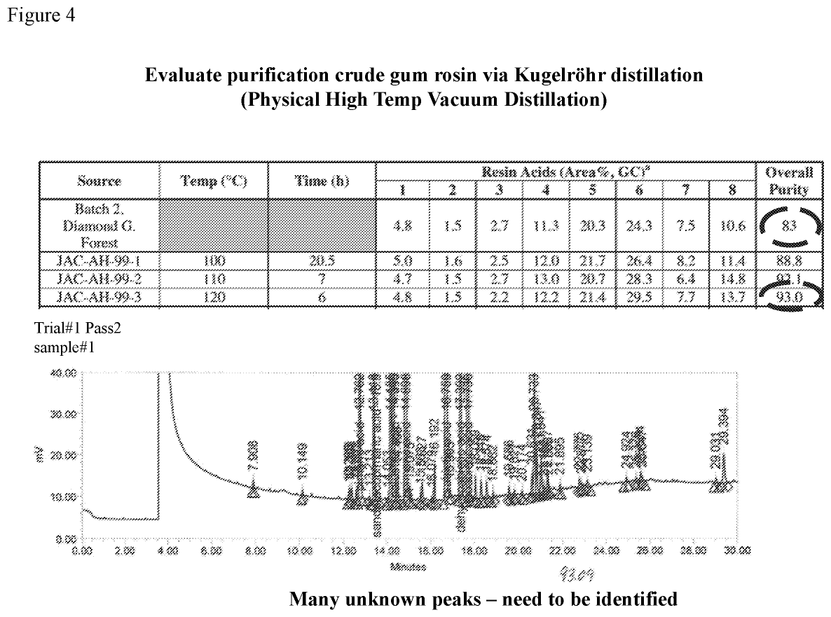

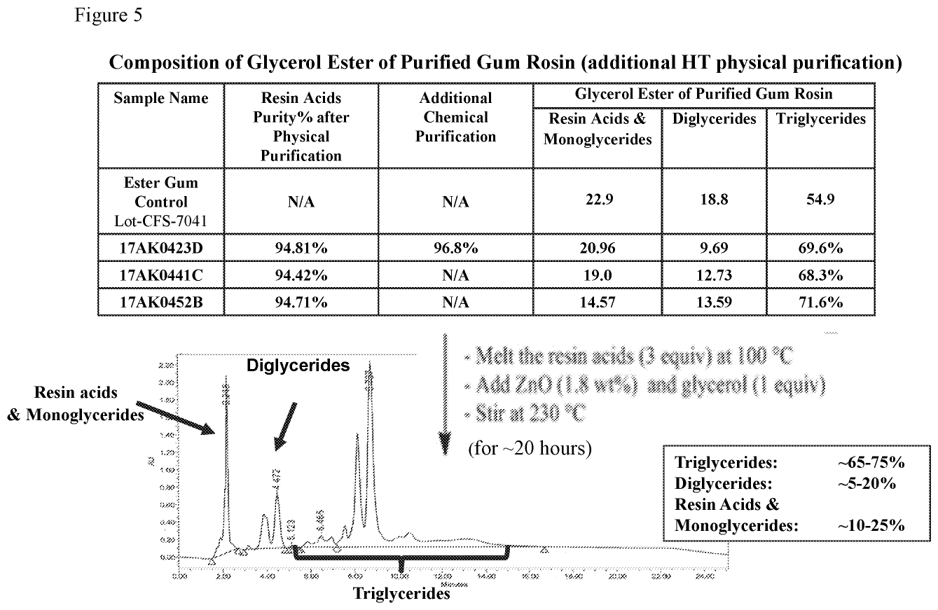

In one embodiment, crude gum rosin contains 50 different compounds, as shown in FIG. 2.

It is known to process rosins to some degree in order to provide products for commercial use. Rosins are processed, for example, to provide refined gum rosins or refined wood rosins that are then further modified to produce commercial products such as glycerol ester of wood rosin or glycerol ester of gum rosin.

Glycerol ester of gum rosin (GEGR), a food additive, is obtained by esterification of refined gum rosin. It is a complex mixture of tri- and diglycerol esters of resin acids from gum rosin, with glycerol triabietate as the main component and a residual fraction of monoglycerol esters. GEGR differs from the weighting agent disclosed herein with respect to one or more characteristics, including but not limited to the percentage of resin acids, the number of resin acids, the percentage of unknown compounds and/or the number of unknown compounds.

In one embodiment, the weighting agent disclosed herein comprises a glycerol ester of purified gum rosin that contains a higher percentage of resin acids that a crude gum rosin or conventional ester gum (i.e., glycerol ester of gum rosin). In a particular embodiment, the weighting agent disclosed herein comprises a glycerol ester of purified gum rosin that contains at least 80%, at least 81%, at least 82%, at least 83%, at least 84%, at least 85%, at least 86%, at least 87%, at least 88%, at least 89%, at least 90%, at least 91%, at least 92%, at least 94%, at least 95%, at least 96%, at least 97%, at least 98% or at least 99% resin acids.

In one embodiment, the weighting agent disclosed herein comprises a glycerol ester of purified gum rosin that contains a number of resin acids that is fewer than a crude gum rosin or conventional ester gum.

In one embodiment, the weighting agent disclosed herein comprises a glycerol ester of purified gum rosin that contains fewer than 40 resin acids, fewer than 30 resin acids, fewer than 20 resin acids, fewer than 15 resin acids or fewer than 10 resin acids.

In another embodiment, the weighting agent disclosed herein comprises a glycerol ester of purified gum rosin contains six, seven, eight, nine, ten, eleven, twelve, thirteen, fourteen or fifteen resin acids.

In yet another embodiment, the weighting agent disclosed herein comprises a glycerol ester of purified gum rosin that contains between 5 and 20 resin acids, between 6 and 18 resin acids, between 8 and 16 resin acids, between 10 and 14 resin acids or 12 resin acids.

In another embodiment, the weighting agent disclosed herein contains a lower percentage of unknown compounds that a conventional ester gum. In a particular embodiment, the weighting agent disclosed herein contains less than 1.0%, less than 0.8%, less than 0.6%, less than 0.4%, less than 0.2%, less than 0.1%, or less than 0.01% unknown compounds.

In a particular embodiment, the weighting agent disclosed herein contains less than about 1.0%, less than about 0.8%, less than about 0.6%, less than about 0.4%, less than about 0.2%, less than 0.1%, or less than 0.01% unknown compounds.

In a particular embodiment, the weighting agent disclosed herein contains fewer unknown compounds that a conventional ester gum. In one embodiment, the weighting agent disclosed herein contains fewer than 15, fewer than 13, fewer than 11, fewer than 9, fewer than 6 or fewer than 3 unknown compounds.

In a particular embodiment, the weighting agent disclosed herein contains a glycerol ester of purified gum rosin that is characterized by an area percentage (%) of resins and monoglycerides by HPLC that is less than the area percentage for a conventional ester gum. In a particular embodiment, the area % by HPLC of the weighted agent disclosed herein is at least about 30% less, at least about 40% less, at least about 50% less, at least about 60% less or at least about 70% less with respect to resin acids and monoglycerides than a conventional ester gum. In another embodiment, the area % by HPLC of the weighted agent of the present invention is about 30%, about 40%, about 50%, about 60% less or about 70% less with respect to resin acids and monoglycerides than a conventional ester gum. In a particular embodiment, the area of the weighted agent described herein is about 5 to about 15%, more particularly, about 10% with respect to resin acids and monoglycerides.

In a particular embodiment, the weighting agent disclosed herein contains a glycerol ester of purified gum rosin that is characterized by an area percentage (%) of diglycerides by HPLC that is less than the area percentage for a conventional ester gum. In a particular embodiment, the area % by HPLC of the weighting agent disclosed herein is at least about 50% less, at least about 60% less, at least about 70% less, at least about 80% less, at least about 90% less or at least about 95% less than the area percentage for a conventional ester gum with respect to diglycerides. In another embodiment, the area % by HPLC of the weighted agent disclosed herein is about 30%, about 40%, about 50%, about 60% less, about 70% less, about 80% less, about 90% less or about 95% less with respect to diglycerides than a conventional ester gum. In a particular embodiment, the area % by HPLC of the weighting agent disclosed herein is about 0.1 to about 2.0%, more particularly, about 0.5 to about 1.5% with respect to diglycerides.

In another particular embodiment, the weighting agent disclosed herein contains a glycerol ester of purified gum rosin that is characterized by an area percentage (%) triglycerides by HPLC that is greater than the area percentage for a conventional ester gum. In a particular embodiment, the area % by HPLC of the weighting agent disclosed herein is at least about 20%, at least about 25%, at least about 30%, at least about 35%, at least about 40%, at least about 45%, at least about 50%, or at least about 55% or more than the area percentage for a conventional ester gum with respect to triglycerides. In another embodiment, the area % by HPLC of the weighting agent disclosed herein is about 20%, about 25%, about 30%, about 35%, about 40%, about 50% or about 55% more than a conventional ester gum. In a particular embodiment, the area % by HPLC of the weighting agent disclosed herein is about 75 to about 95, about 80 to about 90, or about 85%.

In one embodiment, the density of the weighting agent disclosed herein is approximately equal to a conventional ester gum (Pinova, USA) or glycerol ester of gum resin (Resinas, Mexico or Eastman Chemical, USA). Density may be measured, for example, at 50 wt. % and 22° C. As such, the weighting agent disclosed herein can be substituted 1:1 for conventional ester gum in consumables such as beverage emulsions.

In certain embodiments, the weighting agent has a density of between about 0.90 and about 1.10, more particularly, about 0.92 and about 1.0, about 0.94 and about 0.98, about 0.94, about 0.95, about 0.96, about 0.97 or about 0.98.

In a particular embodiment, the weighting agent has a density of between about 0.94 and about 0.96, more particularly, about 0.945 and about 0.955.

In certain embodiments, the weighting agent increases the density of oil phase of the beverage emulsion by about 0.01, about 0.02, about 0.03, about 0.04, about 0.05, about 0.06, about 0.07, about 0.08, about 0.09, about 0.10, about 0.12, about 0.14, about 0.16, about 0.18 or about 0.20 or more.

The weighting agent disclosed herein imparts emulsion stability to the beverage emulsion to which it is added. Emulsion stability generally refers to how the properties of an emulsion changes over time due to measure of how the properties of an emulsion change over time—as a result of one or more of the following: flocculation, creaming, coalescence, and Ostwald ripening. These processes cause changes in droplet size and/or buoyancy which can ultimately lead to phase separation. A stable emulsion remains substantially unchanged over time even under destabilizing conditions such as high temperatures or mechanical agitation.

### III. Beverage Emulsions

In one embodiment, a composition is disclosed comprising the weighting agent of the present invention. In a particular embodiment, the composition is a beverage emulsion. The beverage emulsion may be a beverage concentrate or a finished beverage (i.e., a diluted beverage concentrate).

In a particular embodiment, the beverage emulsion is an oil-in-water emulsion comprising a dispersed oil phase and a continuous aqueous phase.

In one embodiment, the oil phase of the beverage emulsion comprises at least one essential oil, edible oil or flavor oil, and at least one weighting agent as described herein. In certain embodiments, the oil phase of the beverage emulsion contains two or more oils and at least one weighting agent.

The flavor oil may be any suitable flavor oil, including but not limited to, oils obtained from thyme (thymol, carvacrol), oregano (carvacrol, terpenes), lemon (limonene, terpinene, phellandrene, pinene, citral), lemongrass (citral, methylheptenone, citronellal, geraniol), orange flower (linalool, .beta.-pinene, limonene), orange (limonene, citral), anise (anethole, safrol), clove (eugenol, eugenyl acetate, caryophyllene), rose (geraniol, citronellol), rosemary (borneol, bornyl esters, camphor), geranium (geraniol, citronellol, linalool), lavender (linalyl acetate, linalool), citronella (geraniol, citronellol, citronellal, camphene), eucalyptus (eucalyptol); peppermint (menthol, menthyl esters), spearmint (carvone, limonene, pinene); wintergreen (methyl salicylate), camphor (safrole, acetaldehyde, camphor), bay (eugenol, myrcene, chavicol), cinnamon (cinnamaldehyde, cinnamyl acetate, eugenol), tea tree (terpinen-4-ol, cineole), and cedar leaf (.alpha.-thujone, .beta.-thujone, fenchone).

In another embodiment, the flavoring oil is derived plants of the Rutaceae family, e.g. Aegle, Citrus, Casimiroa, Clymenia, Glycosmis and Triphasia; of the Apiaceae family, e.g. angelica, anise, arracacha, asafoetida, caraway, carrot celery, Centella asiatica, chervil, cicely, coriander (cilantro), culantro, cumin, dill, fennel, hemlock, lovage, cow parsley, parsley, parsnip, cow parsnip, sea holly, giant hogweed and silphium; of the Lamiaceae family, e.g Mentha aquatica, Mentha arvensis, Mentha asiatica, Mentha australis, Mentha canadensis, Mentha cervina, Mentha citrata, Mentha crispata, Mentha dahurica, Mentha diemenica, Mentha laxiflora, Mentha longifolia, Mentha piperita, Mentha pulegium, Mentha requienii, Mentha sachalinensis, Mentha satureioides, Mentha spicata, Mentha suaveolens and Mentha vagans; of the Myrtaceae family, e.g. bay rum tree, clove, guava, acca (feijoa), allspice and eucalyptus; of the Lauraceae family, e.g. Actinodaphne, Aiouea, Alseodaphne, Aniba, Apollonias, Aspidostemon, Beilschmiedia, Caryodaphnopsis, Camphora, Cassytha, Chlorocardium, Cinnadenia, Cinnamomum, Cryptocarya, Dehaasia, Dicypellium, Dodecadenia, Endiandra, Endlicheria, Eusideroxylon, Gamanthera, Hufelandia, Hypodaphnis, Iteadaphne, Kubitzkia, Laurus, Licaria, Lindera Litsea, Machilus, Malapoenna, Mespilodaphne, Mezilaurus, Misanteca, Mocinnodaphne, Mutisiopersea, Nectandra, Neocinnamomum, Neolitsea, Notaphoebe, Nothaphoebe, Ocotea, Oreodaphne, Parasassafras, Parthenoxylon, Paraia, Persea, Phoebe, Phyllostemonodaphne, Pleurothyrium, Polyadenia, Potameia, Potoxylon, Povedadaphne, Ravensara, Rhodostemonodaphne. Sassafras, Schauera, Sextonia, Sinopora, Sinosassafras, Syndiclis, Systemonodaphne, Tetranthera, Umbellularia, Urbanodendron, Williamodendron, and Yasunia; or any combination of two or more of these.

In one embodiment, the flavor oil derived from citrus fruits e.g. from the rind of citrus fruits. Citrus fruits include lemons, limes, oranges, tangerines, mandarins, bergamots, and grapefruits. The orange flavor oil may be a sweet orange oil or a bitter orange oil. The orange oil may also be a blood orange oil. Other citrus oils that may be used in the oil phase of the present invention include, but are not limited to, petitgrain oils, yuzu oil, neroli oils and the like.

The oil phase may contain one or more additional components. In one embodiment, the oil phase contains a vegetable oil. The oil phase may also contain other additives, such as antioxidants.

The amount of oil in the beverage emulsion may vary. In a particular embodiment, the beverage emulsion is a beverage concentrate and contains between about 0.5 and about 50%, more particularly, about 10% and about 30% oil, and more particularly, about 3%, about 8%, about 10%, about 13%, about 15%, about 18%, about 21%, about 24%, about 27% or about 30% oil.

In another particular embodiment, the beverage emulsion is a finished beverage and contains between about 0.001 and about 0.8% oil, more particularly, between about, 0.005% and 0.02%, and even more particularly, 0.01%, about 0.02%, about 0.03%, about 0.04%, about 0.05%, about 0.06%, about 0.07%, about 0.08%, about 0.09% or about 0.1% oil.

The amount of oil in the oil phase may vary. In one embodiment, the oil phase contains between about 20 to about 80% oil, more particularly, about 50 and about 80% oil, about 60 and about 70% oil, or about 65% oil. In another embodiment, the amount of oil in the oil phase is about 20%, about 30%, about 40% or about 50% or more.

The ratio of the weighting agent to the flavor oils may vary. In one embodiment, the ratio of the weighting agent to the flavor oil (e.g., citrus oil) is from about 1:100, about 1:50, about 1:25, about 1:20, about 1:10, about 1:5, about 1.3, about 1:2 or about 1:1.

The weighting agent present in the oil phase of the beverage emulsion may vary and include any weighting agent described herein or a combination thereof.

The amount of the weighting agent present in the oil phase of the beverage emulsion may vary. In one embodiment, a beverage emulsion is disclosed comprising the weighting agent disclosed herein, wherein the weighting agent is present in the oil phase of the beverage emulsion in an amount from about 1 ppm to about 200 ppm, about 10 ppm to about 180 ppm, about 20 ppm to about 170 ppm, about 30 ppm to about 160 ppm, about 40 ppm to about 150 ppm, about 50 ppm to about 140 ppm, about 60 ppm to about 130 ppm, about 70 ppm to about 120 ppm, about 80 ppm to about 110 ppm or about 100 ppm.

In a further embodiment, the weighting agent is present in the oil phase of the beverage emulsion in an amount of about 10 ppm, about 20 ppm, about 30 ppm, about 40 ppm, about 50 ppm, about 60 ppm, about 70 ppm, about 80 ppm, about 90 ppm, about 100 ppm, about 110 ppm, about 120 ppm, about 130 ppm, about 140 ppm, about 150 ppm, about 160 ppm, about 170 ppm, about 180 ppm, about 190 ppm or about 200 ppm.

In another embodiment, the weighting agent is present in the oil phase of the beverage emulsion in an amount less than about 200 ppm, less than about 180 ppm, less than about 170 ppm, less than about 160 ppm, less than about 150 ppm, less than about 140 ppm, less than about 130 ppm, less than about 120 ppm, less than about 100 ppm, less than about 90 ppm, less than about 80 ppm, less than about 70 ppm, less than about 60 ppm, less than about 50 ppm, less than about 40 ppm, less than about 30 ppm, less than about 20 ppm, or about 10 ppm or less.

In one embodiment, the diluted beverage emulsion (i.e., the finished beverage) contains about 50 mg/L, about 45 mg/L, about 40 mg/L, about 35 mg/mL, about 30 mg/L, about 25 mg/L or about 20 mg/L or less of a dispersed oil phase.

The beverage emulsion further comprises an aqueous phase, i.e., a water-based phase. The water may represent, for example, between about 40 and about 80% of the beverage emulsion, more particularly between about 50 and about 70% or between about 60 and about 70% of the beverage emulsion, or more particularly, about 40%, about 50%, about 60%, about 70%, or about 80% or more of the beverage emulsion. Water as used herein includes water from all sources, e.g., juice.

The water phase of the beverage emulsion may contain suitable components. In one embodiment, the water contains one or more of the following: water, various types of hydrocolloids, citric acid, preservative, emulsifier, emulsion stabilizers, colorants, thickeners, sweeteners, and salts.

The hydrocolloid may be any suitable hydrocolloid, including, but not limited to, gum arabie, modified food starch, gum tragacanth, propylene glycol alginate, xanthan gum, pectin, gellan gum, guar gum and carboxymethylcellulose.

The emulsifier may be any suitable emulsifier, including, but not limited to, gum acacia, modified food starches (e.g., alkenylsuccinate modified food starches), anionic polymers derived from cellulose (e.g., carboxymethylcellulose), gum ghatti, modified gum ghatti, xanthan gum, tragacanth gum, guar gum, locust bean gum, pectin, and mixtures thereof

The sweetener(s) may be any suitable sweetener, including natural, non-natural, or synthetic sweeteners.

The beverage or beverage concentrate can contain additives including, but not limited to, carbohydrates, polyols, amino acids and their corresponding salts, poly-amino acids and their corresponding salts, sugar acids and their corresponding salts, nucleotides, organic acids, inorganic acids, organic salts including organic acid salts and organic base salts, inorganic salts, bitter compounds, caffeine, flavorants and flavoring ingredients, astringent compounds, proteins or protein hydrolysates, surfactants, emulsifiers, juice, dairy, cereal and other plant extracts, flavonoids, alcohols, polymers and combinations thereof. Any suitable additive described herein can be used.

The beverage or beverage concentrate can contain one or more functional ingredients, detailed herein. Functional ingredients include, but are not limited to, vitamins, minerals, antioxidants, preservatives, glucosamine, polyphenols and combinations thereof.

It is contemplated that the pH of the beverage emulsion, such as, for example, a finished beverage, does not materially or adversely affect the beverage emulsion. A non-limiting example of the pH range of the beverage may be from about 1.8 to about 10. A further example includes a pH range from about 2 to about 5. In a particular embodiment, the pH of beverage can be from about 2.5 to about 4.2. On of skill in the art will understand that the pH of the beverage can vary based on the type of beverage. Dairy beverages, for example, can have pHs greater than 4.2.

The titratable acidity of a beverage may, for example, range from about 0.01 to about 1.0% by weight of beverage.

In one embodiment, the sparkling beverage product has an acidity from about 0.01 to about 1.0% by weight of the beverage, such as, for example, from about 0.05% to about 0.25% by weight of beverage.

The carbonation of a sparkling beverage product has 0 to about 2% (w/w) of carbon dioxide or its equivalent, for example, from about 0.1 to about 1.0% (w/w).

The temperature of a beverage may, for example, range from about 4° C. to about 100° C., such as, for example, from about 4° C. to about 25° C. The beverage may be a shelf stable beverage or a chilled beverage.

The calorie content of the beverage can vary. In one embodiment, the beverage is a full-calorie beverage that has up to about 120 calories per 8 oz serving. In another embodiment, the beverage is a mid-calorie beverage that has up to about 60 calories per 8 oz. serving. In still another embodiment, the beverage is a low-calorie beverage that has up to about 40 calories per 8 oz. serving. In yet another embodiment, the beverage can be a zero-calorie that has less than about 5 calories per 8 oz. serving.

In a particular embodiment, the beverage is a cola beverage. In a more particular embodiment, the cola beverage further comprises caffeine. In another more particular embodiment, the cola beverage can be a low-, mid- or zero-calorie beverage.

In a particular embodiment, the beverage is a lemon-lime flavored or orange flavored soda.

In particular embodiment, the finished beverage is a carbonated soft drink prepared by diluting a beverage syrup at about 10% (v/v) in aqueous solutions of sugars, coloring, and preservatives. In a particular embodiment, the beverage syrup comprises at least one citrus oil, e.g., orange oil. In another embodiment, the finished beverage is a juice.

The beverage emulsion, in both its concentrated and diluted form (including carbonated diluted forms), is characterized by a desired degree of stability. Specifically, the beverage emulsion exhibits suitable stability (e.g., chemical stability, physical stability). for commercial use, both in the concentrated and diluted (finished) form.

Stability can be measured by any suitable technique. Stability can be measured by indirect methods (e.g., PSD) or direct methods (e.g., visual observation, including imaging techniques). In certain embodiments, stability is measured by a technique selected from light scattering, focused beam reflectance measurements, centrifugation, and rheology. In a particular embodiment, the beverage emulsion passes the “ringing test” described by Tan and Holmes, “Stability of beverage flavour emulsions’. Perfumer and Flavourist 1988, 13, 23-41 (see protocol 3).

In a particular embodiment, the beverage emulsion has a stability index greater than 0.9, greater than 0.92, greater than 0.93, greater than 0.94, greater than 0.95, greater than 0.96, greater than 0.97, greater than 0.98, greater than 0.99, greater than 1.00, greater than about 1.01, greater than about 1.03, greater than about 1.05, greater than about 0.108 or greater than about 0.110.

In one embodiment, the beverage emulsion exhibits stability similar or equal to a beverage emulsion comprising conventional ester gum, e.g., glycerol ester of gum rosin (Eastman Chemical, USA). In other embodiments, the beverage emulsion exhibits stability that is improved relative to a beverage emulsion comprising a conventional ester gum. The improvement may be, for example, about 5%, about 10%, about 15% or about 20% or more. In a particular embodiment, the improvement is exhibited at a temperature of about 23° C. or greater, more particularly, greater than about 30° C.

In another embodiment, the beverage emulsion of the present invention is characterized by a mean particle size that is similar to a beverage emulsion comprising a conventional ester gum. In a further embodiment, the beverage emulsion is characterized by a mean particle size that is reduced compared to the mean particle size of a beverage emulsion comprising a conventional ester gum. In one embodiment, the mean particle size of the beverage emulsion of the present invention is reduced by about 10%, about 15%, about 20% or about 25% or more.

In a particular embodiment, the mean particle size of the beverage emulsion is reduced by the addition of the weighting agent of the present invention. In a particular embodiment, the mean particle size is reduced by about 1%, about 5%, about 10% or about 20% or more.

In a particular embodiment, the beverage emulsion is characterized by a mean particle size between about 0.05 and about 0.3 microns for a suitable period of time. In another embodiment, the beverage emulsion has a mean particle size of between about 0.08 and about 0.26, between about 0.10 and about 0.20, more particularly, between about 0.12 and about 0.18. In a particular embodiment, the beverage emulsion has a mean particular size of about 0.08, about 0.10, about 0.12, about 0.14, about 0.16, about 0.18, about 0.20, about 0.22, about 0.24 or about 0.26 microns. In a particular embodiment, the mean particle size is maintained for at least three (3) months, at least six (6) months or at least twelve (12) months or longer, when stability is measured at room temperature.

In certain embodiments, the beverage emulsion is characterized by a mean particle size of less than about 0.05 microns for a suitable time, more particularly, about 0.45 microns, about 0.40 microns, about 0.35 microns, about 0.30 microns, about 0.25 microns, about 0.20 microns, about 0.15 microns or about 0.01 microns or less. In a particular embodiment, the mean particle size is maintained for at least three (3) months, at least six (6) months or at least twelve (12) months or longer, when stability is measured at room temperature.

In one embodiment, the beverage emulsion is characterized by a particle size remains between 0.1 and 0.2 microns for at least three (3) months, at least six (6) months or at least twelve (12) months or longer, when stability is measured at room temperature.

In one embodiment, the beverage emulsion exhibits slower phase separation than a beverage emulsion comprising conventional ester gum, e.g., glycerol ester of gum rosin. In a particular embodiment, the phase separation of the beverage emulsion disclosed herein is about 5%, about 10%, about 15%, about 20% or about 25% slower than a beverage emulsion comprising a conventional ester gum. In another embodiment, the phase separation of the beverage emulsion is about 3, about 5 or about 10 times slower than a beverage emulsion comprising a conventional ester gum. In a particular embodiment, the improvement is exhibited at a temperature of about 22° C. or greater, or more particularly, greater than about 30° C.

In one embodiment, the beverage emulsion exhibits similar or equal flocculation, flotation, sedimentation and/or coalescence relative to a beverage emulsion comprising a conventional ester gum. In another embodiment, one or more of these properties is improved in the beverage emulsion of the present invention relative to a beverage emulsion comprising a conventional ester gum. The improvement may be, for example, about 5%, about 10%, about 15% or about 20% or more. In a particular embodiment, the improvement is exhibited at a temperature greater than about 30° C.

In another embodiment, the beverage emulsion exhibits similar or equal lifting or striating compared to a beverage emulsion comprising a conventional ester gum. In other embodiments, the amount of lifting or striating is decreased in the beverage emulsion of the present invention. The reduction may be, for example, about 5%, about 10%, about 15% or about 20% or more. In a particular embodiment, the improvement is exhibited at a temperature greater than about 30° C.

In another embodiment, the beverage emulsion of the present invention (as packaged) exhibits a similar or equal shelf life to a beverage emulsion comprising conventional ester gum e.g., glycerol ester of gum rosin (Eastman Chemical, USA). In a particular embodiment, the shelf life is between about 4 and about 12 weeks. In another embodiment, the emulsion exhibits stability that is improved relative to a beverage emulsion comprising a conventional ester gum. The improvement may be, for example, about 5%, about 10%, about 15% or about 20% or more.

In another particular embodiment, the beverage emulsion (as packaged) has a shelf life of about 6, about 8, about 10, about 12, about 14, about 16 or about 18 months or more.

In another particular embodiment, the beverage emulsion (as packaged) has a shelf life of about 1 year, about 1.5 years, about 2.0 years, about 2.5 years or about 3.0 years or more.

The sensory characteristics of the beverage containing the weighting agent of the present invention are suitable for use by consumers. Specifically, the appearance (e.g., color), taste, aroma, mouthfeel and overall acceptability is suitable. In one embodiment, one or more sensory characteristics of the beverage are improved relative to beverages containing conventional ester gum. Sensory properties may be tested, for example, at 0° and 22° C., by trained panelists (e.g., 4-5). In alternate embodiments, sensory properties may be tested by appropriate instruments (e.g., rheometers, penetrometer, spectrophotometer), either alone or in combination with sensory panelists. Consumer panels, e.g., generally untrained panelists, may also be used to determine sensory properties.

In one embodiment, the present invention provides a beverage product comprising the weighing agent of the present invention. “Beverage product”, as used herein, is a ready-to-drink beverage, a beverage concentrate, a beverage syrup, or a powdered beverage. Suitable ready-to-drink beverages include carbonated and non-carbonated beverages. Carbonated beverages include, but are not limited to, frozen carbonated beverages, enhanced sparkling beverages, cola, fruit-flavored sparkling beverages (e.g. lemon-lime, orange, grape, strawberry and pineapple), ginger-ale, soft drinks and root beer. Non-carbonated beverages include, but are not limited to, fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g. black tea, green tea, red tea, oolong tea), coffee, cocoa drink, beverage containing milk components (e.g. milk beverages, coffee containing milk components, café au lait, milk tea, fruit milk beverages), beverages containing cereal extracts and smoothies.

In a particular embodiment, the fruit juice is selected from the group consisting of citrus juices and non-citrus juices. The citrus juice may be, for example, orange juice, lemon juice, lime juice, grapefruit juice, tangerine juice or mixtures thereof. The non-citrus juice may be, for example, apple juice, grape juice, pear juice, cherry juice, berry juice, pineapple juice, peach juice, apricot juice, plum juice, prune juice, etc., and mixtures of these juices.

In one embodiment, the beverage product is an oil-in-water emulsion. Beverage emulsions are thermodynamically unstable systems that tend to break down during storage. Several breakdown processes may occur, including creaming and sedimentation, flocculation, Oswald ripening, coalescence, phase inversion or a combination thereof. In certain embodiments, the beverage emulsion described herein has reduced breakdown compared to beverage emulsions known in the art.

In another embodiment, the consumable disclosed herein is a food or food product. The food product may be an oil-in-water emulsion (e.g., butter) or a water-in-oil emulsion. In a particular embodiment, the food product is a food emulsion such as a spreadable butter or margarine, ice cream or the like.

### IV. Methods of Preparing the Weighting Agent

The weighting agent disclosed herein is prepared from natural sources, such as plants belonging to Pinaceae (mainly Pinus genus).

In one embodiment, the weighting agent is prepared from a rosin obtained from a pine tree species selected from the group consisting of P. elliottii Engelm ((Brazil, Argentina, S. Africa, USA, Kenya), P. massoniana and P. kesiya Royale ex Gordon (China), P. pinaster Aiton (Portugal), P. merkusii Jungh. and Vriese (Indonesia and Viet Nam), P. roxburghii Sarg. (India and Pakistan), P. oocarp Schilde (Mexico and Hondorans), P. caribaea (S. Africa, Kenya, Venezuela), and P. radiata (Kenya). In another embodiment, the purified gum resin is derived from another conifer or broad leaf tree.

Oleoresin can be tapped from living trees by means of a repeated wounding process, which removes the bark and tissues beneath it, optionally followed by application of a chemical stimulant. Once collected, the crude oleoresin is subject to distillation to provide gum turpentine (the volatile fraction) and crude gum rosin (the solid fraction).

Crude gum rosin consists primarily of a mixture of abietic- and pimaric-type acids with smaller amounts of neutral compounds. The neutral compounds primarily include stilbene compounds and other hydrocarbons. In some embodiments, crude gum rosin consists of about 80% resin acids and about 10% neutral compounds. In one embodiment, crude gum rosin contains 50 different compounds, as shown in FIG. 2.

Thus, in one embodiment, a method is disclosed for obtaining a weighting agent, comprising (i) providing a crude gum rosin; (ii) purifying the crude gum rosin in order to obtain a weighting agent.

Any suitable method of purification can be used. In one embodiment, the purification method is a physical purification method (batch or continuous distillation), a chemical purification method (e.g., salt formation) or a combination of both.

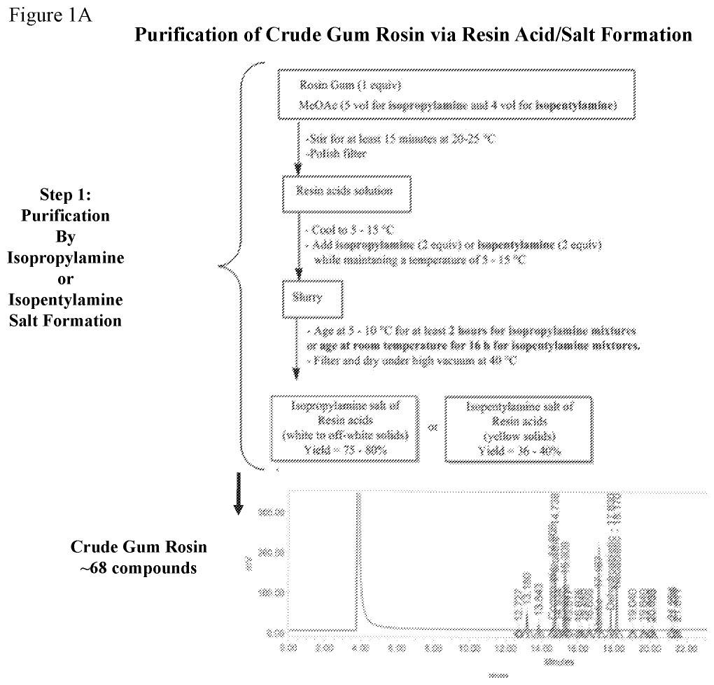

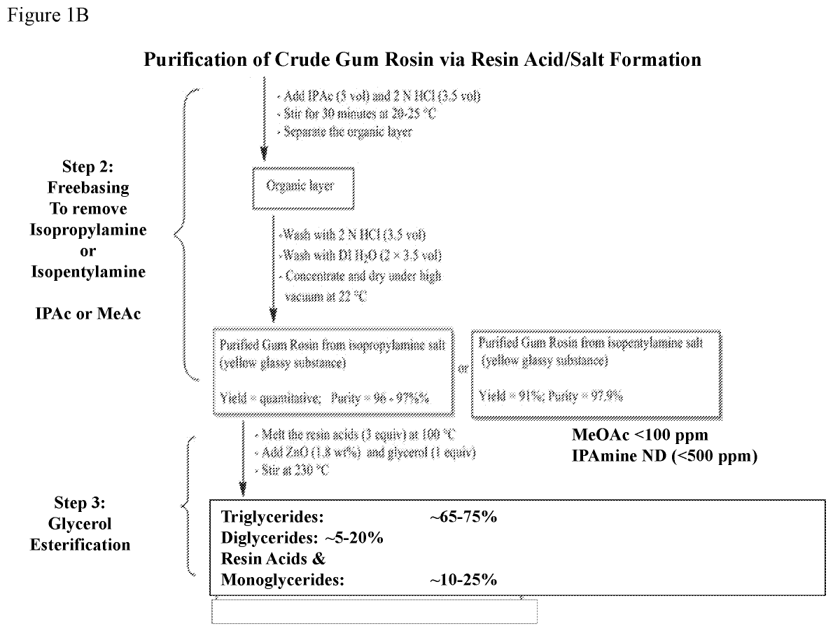

In one embodiment, the purification of crude gum rosin is via resin acid/salt formation. In a particular embodiment, the method involves (i) purification of the crude gum rosin by isopropylamine or isopenthylamine salt formation; (ii) freebasing to remove isopropylamine or isopentylamine and (iii) glycerol esterification. A representative chemical method of purification is shown in FIG. 1, hereto.

In another embodiment, the purification method involves distillation, i.e., the separation of compounds based on differences in boiling point. In a particular embodiment, the method involves vacuum distillation or molecular distillation (i.e., vacuum distillation below the pressure of 0.01 torr).

In a particular embodiment, the method involves high temperature vacuum distillation (Kugelrohr distillation). The process may be a batch process. The time and temperature may vary. In one embodiment, the temperature is between about 100 and about 120° C., or more particularly, about 100, about 105, about 110, about 115 or about 120° C. In another embodiment, the time is between about 5 and about 25 hours, more particularly, about 10 and about 20 hours, or more particularly about 15 hours. In a particular embodiment, the time is between about 5 and about 10 hours, or about 5, about 6, about 7, about 8, about 9 or about 10 hours.

In a particular embodiment, purification of crude gum rosin via vacuum distillation provides a weighting agent comprising between about 80 and about 95% resin acids, and more particularly, between about 83 and 93% resin acids, or about 83%, about 84%, about 85%, about 86%, about 87%, about 88%, about 89%, about 90%, about 91%, about 92% or about 93%. In one embodiment, the number of resin acids is less than 12, less than 11, less than 10, less than 9 or less than 8. In another embodiment, the number of resins is between 6 and 12, between 8 and 12 or 10.

In another embodiment, the purification method involves molecular distillation (also known as wiped film distillation). Advantageously, this method is continuous/scalable.

In a particular embodiment, purification of crude gum rosin via vacuum distillation provides a weighting agent comprising between about 80 and about 95% resin acids, and more particularly between about 90 and about 95% resin acids, and even more particularly, about 93%, about 94% or about 95% resin acids. In one embodiment, the number of resin acids is less than 12, less than 11, less than 10, less than 9 or less than 8. In another embodiment, the number of resins is between 6 and 12, between 8 and 12 or 10.

In a particular embodiment, purification of crude gum rosin via vacuum distillation provides a weighting agent comprising between about 90 and about 99% resin acids, and more particularly between about 92 and about 97% resin acids, and even more particularly, about 96%, about 97%, about 98% or about 99% resin acids. In one embodiment, the number of resin acids is less than 12, less than 11, less than 10, less than 9 or less than 8. In another embodiment, the number of resins is between 6 and 12, between 8 and 12 or 10.

In certain embodiments, the method of the present invention is carried out at lab scale (about 1 kg). In a particular embodiment, the yield is about 85% and the purity is between about 90 and about 95%, more particularly about 92% resin acids. In certain embodiments, the weighting agent prepared by this method contains 12 or fewer resin acids, more particularly 10 resin acids.

In other embodiments, the method is carrier out at pilot scale (i.e., about 100-200 kgs). In a particular embodiment, the yield is about 90% and the purity is between about 90 and about 94% resin acids, more particularly about 94% resin acids. In certain embodiments, the weighting agent prepared by this method includes 10 or fewer resin acids, or more particularly, 8 resin acids.

In one embodiment, the weighting agent disclosed herein has a greater purity and fewer resin acids than weighting agents known in the art and more particularly, conventional ester gums. In a particular embodiment, the purity is at least 5% greater and the number of resin acids is at least 50% fewer. In certain embodiments, the purity is at least 10% greater and the number of resin acids is at least 75% fewer.

### V. Methods of Preparing Beverage Emulsions

In one embodiment, a method of preparing a beverage emulsion containing the weighting agent of the present invention is disclosed comprising adding an effective amount of the weighting agent to the consumable.

Where the consumable is a beverage emulsion, the emulsion may be prepared by any method known in the art. In one embodiment, the ingredients are mixed together and then homogenized. Methods of homogenization include, but are not limited to, high-pressure homogenizing, high shear mixing, sonicating, and other mixing techniques known to those skilled in the art.

Beverage concentrates and beverage syrups are prepared with an initial volume of liquid matrix (e.g. water) and the desired beverage ingredients. Full strength (finished) beverages are then prepared by adding further volumes of water. Powdered beverages are prepared by dry-mixing all of the beverage ingredients in the absence of a liquid matrix. Full strength beverages are then prepared by adding the full volume of water.

In one embodiment, the method of preparing the beverage emulsion of the present invention comprises (i) preparing the water phase and the oil phase, separately; (ii) pre-homogenization; and (iii) homogenization.

The water phase may be prepared by adding together the necessary components.

The oil phase may be prepared by adding together the necessary components. In one embodiment, the flavor oil is added before the weighting agent.

In the pre-homogenization step, the water phase is mixed with the oil phase to create a premix, which breaks the oil into small oil droplets.

In the homogenization step, the pre-ix is pumped through the homogenizer's valves at very high pressure. This creates turbulence and cavitation forces, which break the oil droplets down into fine particles.

In one embodiment, the method is used to prepare a citrus beverage, such as a juice or citrus flavored soda.

### EXAMPLES

### Example 1: Density

The density of the weighting agent of the present invention was compared to the density of conventional glycerol esters of wood and/or gum rosins. The results are provided in Table I, below.

TABLE I
Density

| | | Density of 50 wt % |
|---|---|---|
| Ingredient | Supplier | Rosin at 22° C. |
| Glycerol ester of | Pinova USA | 0.9500 |
| wood rosin (Ester | | |
| Gum) | | |
| Glycerol ester of | Resinas, Mexico | 0.9503 |
| gum rosin | | |
| Glycerol ester of | Eastman | 0.9502 |
| gum rosin | Chemical, USA | |
| Glycerol ester of | | 0.9544 |
| Purified Gum | | |
| Rosin (disclosed | | |
| herein). | | |

The data indicates that there is no issue in replacing ester gum 1:1 replacement ratio of conventional ester gums.

### Example 2: Purification of Crude Gum Rosin by Vacuum Distillation

The purification of the crude gum resin was carried out via two different methods of vacuum distillation.

The results of the first method, physical high temperature vacuum distillation, are shown below in Table II.

TABLE II
Purification of Crude Gum Rosin via Kugelrohr Distillation

| | Temp | Time | Resin Acids (Area %, GC)^{a} | | | | | | | | Overall |
|---|---|---|---|---|---|---|---|---|---|---|---|
| Source | (° C.) | (h) | 1 | 2 | 3 | 4 | 5 | 6 | 7 | 8 | Purity |
| Batch 2, | | | 4.8 | 1.5 | 2.7 | 11.3 | 20.3 | 24.3 | 7.5 | 10.6 | 83 |
| Diamond G, | | | | | | | | | | | |
| Forest | | | | | | | | | | | |
| JAC-AH-99-1 | 100 | 20.5 | 5.0 | 1.6 | 2.5 | 12.0 | 21.7 | 26.4 | 8.2 | 11.4 | 88.8 |
| JAC-AH-99-2 | 110 | 7 | 4.7 | 1.5 | 2.7 | 13.0 | 2037 | 28.3 | 6.4 | 14.8 | 92.1 |
| JAC-AH-99-3 | 120 | 6 | 4.8 | 1.5 | 2.2 | 12.2 | 21.4 | 29.5 | 7.7 | 13.7 | 93.0 |

The results of the second method, molecular distillation (wiped film distillation) is shown below in Table III:

TABLE III
Purification of Crude Gum Resin vis Molecular Distillation

| | Resin Acids (Area %, GC) | | | | | | | | Other Acids | | Overall |
|---|---|---|---|---|---|---|---|---|---|---|---|
| Source | 1 | 2 | 3 | 4 | 5 | 6 | 7 | 8 | 9 | 10 | Purity |
| Batch 2, | 4.8 | 1.5 | 2.7 | 11.3 | 20.3 | 24.3 | 7.5 | 10.6 | 0.5 | 0.9 | 83 |
| Diamond G. | | | | | | | | | | | |
| Forest | | | | | | | | | | | |
| JAC-AH-112-1 | 4.6 | 1.4 | 3.1 | 13.2 | 19.8 | 27.4 | 5.5 | 15.5 | 0.7 | 1.2 | 92.4 |
| Batch 2, | 5.9 | 1.8 | 2.6 | 9.8 | 24.3 | 22.0 | 12.4 | 6.0 | 0.4 | 0.7 | 85.9 |
| Diamond G. | | | | | | | | | | | |
| Forest | | | | | | | | | | | |
| JAC-AH-115-1 | 4.5 | 1.4 | 2.9 | 11.5 | 19.8 | 29.8 | 5.8 | 14.5 | 0.6 | 1.0 | 91.8 |

### Example 3: Comparison of Purity by Purification Process

|Comparison of Resin Acid Purity between Different Purification Processes -
Chemical (Salt Formation) vs Physical (Batch vs Continuous Distillation Process)

| | | | Physical HT Vacuum Distillation | | | |
|---|---|---|---|---|---|---|
| | | | | Continuous Wiped Film Distillation Proces - | | |
| | As Is | Chemical | | Molecular Distillation (high surface area) | | |
| | Control | Batch Chemical | Batch Distillation - | Trial #1 | Trial #1 | Trial #2 |
| | Raw Ing. | Purification | Long Time | Pass #2 | Pass #2 | Pass #2 |
| Major Resin Acids | Batch 2 | JAC-AH-2-2 | JAC-AH-99-3 | Sample#1 | Sample#2 | Sample |
| Distillation Temperature | — | — | 129 | 140 | 130 | 140 |
| Feed Rate | — | >48 hours | 6 hours | 500 g/hr | | 400 g/hr |
| Vacuum (mm Hg) | | — | — | 0.06 | 0.06 | 0.02 |
| Pimaric Acid Me ester | 4.8 | 5.3 | 4.8 | 4.14 | 4.74 | 4.46 |
| Sandaracopimaric Acid Me ester | 1.5 | 1.8 | 1.5 | 1.41 | 1.44 | 1.47 |
| Communic Acid Me ester | 2.7 | 0.7 | 2.2 | 2.55 | 2.71 | 2.47 |
| Palustric Acid Me ester | 11.3 | 19.5 | 12.2 | 11.99 | 11.96 | 10.61 |
| Isopimaric Acid Me ester | 20.3 | 23.3 | 21.4 | 19.96 | 20.53 | 20.23 |
| Abietic Acid Me ester | 24.3 | 26.9 | 29.5 | 31.83 | 31.06 | 33.15 |
| Dehydroabietic Acid Me ester | 7.5 | 6.5 | 7.7 | 5.94 | 6.12 | 6.17 |
| Neoabietic Me ester | 10.6 | 14.4 | 13.7 | 16.99 | 15.86 | 15.12 |
| % Resin Add Purity | 83 | 98.4 | 93 | 94.81 | 94.42 | 93.68 |
| Process - % yield | — | ~75% | ~85.5% | 83.1% | 90.2% | 92.1% |
| % unknown | ~17% | 1.6% | 0.33% | 0.59% | 0.98% | 0.83% |
| % unknown - | — | — | ~3% | ~3% | ~3% | ~3% |
| low confidence level | | | | | | |
| % unknown identified | ~7% | ~1.5% | 6.69% | 4.01% | 3.62% | 4.66% |
| % known | ~90% | 99.9% | 99.69% | 99.41% | 99.02% | 99.17% |

1. A weighting agent, comprising (i) at least about 92% resin acids; (ii) about 1% or less unknown compounds; wherein the weighting agent comprises fewer than 12 resin acids.

2. The weighting agent of claim 1, comprising at least about 94% resin acids.

3. The weighting agent of claim 1, wherein the weighting agent comprises fewer than 10 resin acids.

4. A beverage emulsion comprising an effective amount of the weighting agent of claim 1.

5. The beverage emulsion of claim 4, wherein the oil phase of the beverage emulsion comprises a citrus oil.

6. The beverage emulsion of claim 4, wherein the beverage emulsion is a beverage concentrate.

7. The beverage emulsion of claim 6, wherein the beverage concentrate is a beverage syrup for use in making citrus flavored soft drinks.

8. The beverage emulsion of claim 4, wherein the beverage emulsion is a finished beverage.

9. The beverage emulsion of claim 4, wherein the beverage emulsion is stable for greater than about 4 months.

10. The beverage emulsion of claim 4, wherein the beverage emulsion is stable for greater than about 6 months.

11. A method of making the weighting agent of claim 1, comprising (i) providing a suitable starting material; (ii) purifying the starting material by a method selected from the group consisting of chemical purification methods, physical purification methods or a combination therein, thereby providing the weighting agent.

12. The method of claim 11, wherein the suitable starting material is a crude gum rosin.

13. The method of claim 11, wherein the chemical method comprises the steps shown in FIG. 1.

14. The method of claim 11, wherein the physical method comprises vacuum distillation.

15. The method of claim 14, wherein the vacuum distillation comprises molecular distillation.

16. The method of claim 11, wherein the weighting agent comprises at least about 92% resin acids.

17. The method of claim 11, wherein the weighting agent comprises at least about 94% resin acids.

18. The method of claim 11, wherein the weighting agent comprises 10 or fewer resin acids.

19. A method of preparing the beverage emulsion of claim 4, comprising (i) preparing a water phase and an oil phase, separately; (ii) combining the water phase and the oil phase to provide a pre-homogenized composition; and (iii) homogenizing the pre-homogenized composition to provide the beverage emulsion.

20. The method of claim 17, wherein the beverage emulsion is a beverage concentrate or finished beverage.
